(19) United States
(12) Patent Application Publication
(10) Pub. No.: US 2018/0073686 A1
(43) Pub. Date: Mar. 15, 2018

(54) SOLID STATE LIGHTING DEVICE WITH ELECTRONICALLY ADJUSTABLE LIGHT BEAM DISTRIBUTION

(71) Applicants: Michael A. Quilici, Essex, MA (US); Seung Cheol Ryu, Marblehead, MA (US)

(72) Inventors: Michael A. Quilici, Essex, MA (US); Seung Cheol Ryu, Marblehead, MA (US)

(73) Assignee: OSRAM SYLVANIA Inc., Wilmington, MA (US)

(21) Appl. No.: 15/264,690

(22) Filed: Sep. 14, 2016

(51) Int. Cl. F21K 9/233; H05B 33/08; F21K 9/64; F21K 9/69; F21K 9/62; F21K 9/238

(52) U.S. Cl. CPC F21K 9/233; H05B 33/0896; H05B 33/0845; F21K 9/238; F21K 9/64; F21K 9/69; F21K 9/62; H05B 33/0857

(57) ABSTRACT

A lighting device including one or more solid state light sources having an electronically adjustable light beam distribution is disclosed. The lighting device may be a lamp configured to include one or more light source modules, each including one or more solid-state emitters populated over a printed circuit board (PCB). The lamp further may include one or more optics configured to modify the output of its one or more light source modules. For a given module, the one or more emitters thereof may be arranged, for example, in a matrix, cellular array, concentric array, or other arrangement, as desired for a given target application or end-use. A given emitter may be addressable individually, in one or more groupings, or both. In some cases, a lamp provided as described herein may be configured for retrofitting existing lighting structures.

### TECHNICAL FIELD

The present invention relates to lighting, and more specifically, to control of output of lighting devices.

### BACKGROUND

Traditional adjustable lighting fixtures, such as those utilized in theatrical lighting, employ mechanically adjustable lenses, track heads, gimbal mounts, and other mechanical parts to adjust the angle and direction of the light output thereof. Mechanical adjustment of these components is normally provided by actuators, motors, or manual adjustment by a lighting technician. However, the cost of such designs is normally high given the complexity of the mechanical equipment required to provide the desired degree of adjustability. In addition, existing designs generally include relatively large components, making their form factors too large for retrofit applications.

### SUMMARY

For adjusting light distribution, existing lighting designs rely upon mechanical movements provided using motors or other moving components manipulated by a user. However, the cost of such designs is normally high given the complexity of the mechanical equipment required to provide the desired degree of adjustability. In addition, existing designs generally include relatively large components, making their form factors too large for retrofit applications. Existing approaches to providing electronically adjustable light distributions generally suffer from low resolution or density of illumination points and relatively large luminaire size.

Embodiments provide a lighting device including solid state light sources with an electronically adjustable light beam distribution. A lighting device configured as described herein may include one or more light source modules, each including one or more solid-state emitters populated over a printed circuit board (PCB). In some embodiments, a given light source module may be of a chip-on-board configuration, whereas in some embodiments, individual emitter packages may be surface-mounted over a PCB. The lighting device further may include one or more optics configured to modify the output of its one or more light source modules, in accordance with some embodiments. For a given module, the one or more emitters thereof may be arranged, for example, in a matrix, a cellular array, a concentric array, or any other arrangement, as desired for a given target application or end-use. In accordance with some embodiments, a given emitter may be addressable individually, in one or more groupings, or both. In some embodiments, a lighting device provided as described herein may be configured for retrofitting existing lighting structures. Numerous configurations and variations will be apparent in light of this disclosure.

In some embodiments, a lighting device is configured so that its light output is electronically adjusted. To that end, the emitter(s) of a given light source module may be addressable individually, in one or more groupings (e.g., as a partial or full array or other grouping), or both, and thus may be electronically controlled individually, in one or more groupings, or both, to customize emissions thereof. Also, the output of a given light source module may pass through one or more optics hosted by the lighting device. Thus, a given electro-optic tunable optical element or other optic may provide further opportunity for electronic manipulation of one or more attributes of the output of a given light source module, in accordance with some embodiments. Electronic control of a given emitter or optic may be provided, in part or in whole, by a controller, a driver, or both, in accordance with some embodiments. In some cases, a graphical user interface (GUI) or other control interface may be provided to facilitate light distribution adjustments.

In accordance with some embodiments, a lighting device provided as described herein may be configured for customization of its output. To that end, any one, or combination, of beam direction, beam angle, beam size, beam distribution, intensity, and color (among other output attributes) may be electronically manipulated, in accordance with some embodiments. Thus, in accordance with some embodiments, a lighting device configured as described herein may be controlled to produce any desired static or dynamic light distribution, for instance, without need for mechanical movements or mechanically moving parts, contrary to existing lighting systems. Such electronic adjustments may be performed automatically, upon instruction (e.g., from a user or other source), or both. In some cases, pixelated control over the light distribution of a lighting device configured as described herein may be provided.

In accordance with some embodiments, a lighting device configured as described herein may provide for flexible and easily adaptable lighting and be capable of accommodating any of a wide range of lighting applications and contexts. For instance, some embodiments may provide for accent lighting or area lighting of any of a wide variety of distributions, such as, for example, narrow, wide, asymmetric/tilted, Gaussian, batwing, or other specifically shaped beam distribution, to name a few. Some embodiments may provide for downlighting adaptable to small or large area tasks (e.g., high intensity with adjustable distribution and directional beams). Some embodiments may provide for uniform illumination on a given target surface. Some embodiments may provide for filling a given target space with light. Numerous suitable uses will be apparent in light of this disclosure.

In some cases, provision of a lighting device including one or more light source modules configured as described herein may realize a reduction in the quantity of components and the amount of electrical wiring as compared to existing designs. In some instances, a light source module configured as described herein may be substantially planar in design, which may eliminate or otherwise reduce difficulties typically associated with mounting individual solid-state light sources on a curved or other non-planar surface. In some cases, all (or some sub-set) of the emitters of a lighting device configured as described herein may share one or more optics, realizing a reduction in the total quantity of optics and total cost as compared to a lighting device in which each constituent emitter has its own optics. In some instances, a lighting device provided as described herein may be configured for retrofitting sockets/enclosures typically used in existing luminaire structures. Thus, such a lighting device may be considered, in a general sense, a retrofit or other drop-in replacement lighting component for use in existing lighting infrastructure, in accordance with some embodiments.

In an embodiment, there is provided a [insert prose-ification of the claims here].

### BRIEF DESCRIPTION OF THE DRAWINGS

The foregoing and other objects, features and advantages disclosed herein will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIGS. 1A-1B are side and cross-sectional views, respectively, of a lighting device including solid state light sources configured according to embodiments disclosed herein.

FIG. 2 is a cross-sectional view of a lighting device configured according to embodiments disclosed herein.

FIG. 3A is a cross-sectional side view of a light source module configured according to embodiments disclosed herein.

FIG. 3B is a cross-sectional side view of a light source module configured according to embodiments disclosed herein.

FIG. 4A illustrates a plan view of a light source module including a matrix of emitters configured according to embodiments disclosed herein.

FIG. 4B illustrates an electrical schematic of the light source module of FIG. 4A.

FIG. 5 illustrates a plan view of a light source module including a cellular array of emitters configured according to embodiments disclosed herein.

FIG. 6 illustrates a plan view of a light source module including a concentric array of emitters configured according to embodiments disclosed herein.

FIG. 7A is a block diagram of a lighting system including a lighting device hosting a controller configured according to embodiments disclosed herein.

FIG. 7B is a block diagram of a lighting system including a lighting device and a controller therefor configured according to embodiments disclosed herein.

FIGS. 8A-8B illustrate an example light beam distribution produced via a lighting device including a light source module configured as in FIGS. 4A-4B, according to embodiments disclosed herein.

FIG. 9 illustrates an example light beam distribution produced via a lighting device including a light source module configured as in FIG. 5, according to embodiments disclosed herein.

FIG. 10 illustrates an example light beam distribution produced via a lighting device including a light source module configured as in FIG. 6, according to embodiments disclosed herein.

### DETAILED DESCRIPTION

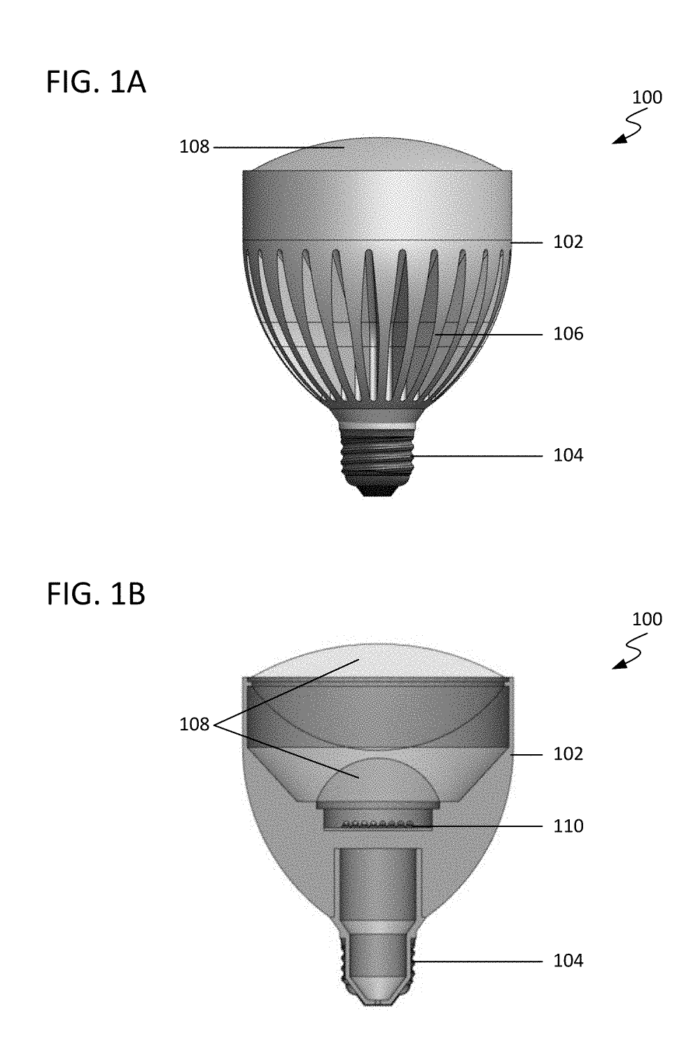

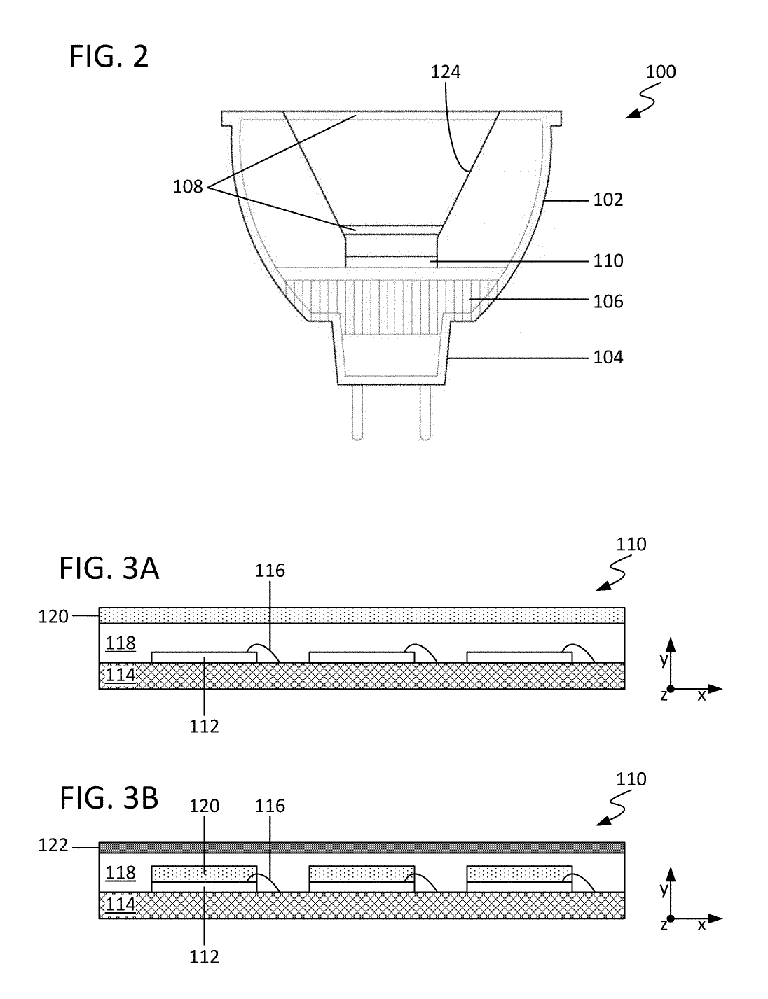

For ease of description, embodiments are described throughout with reference to a lamp (i.e., a lighting device having a socket similar to a socket found on a traditional light source), though embodiments are not so limited and include any known type of lighting device. FIGS. 1A-1B are side and cross-sectional views, respectively, of a lamp 100 including one or more solid state light sources configured in accordance with an embodiment of the present disclosure. FIG. 2 is a cross-sectional view of a lamp 100 configured in accordance with another embodiment of the present disclosure. As will be appreciated in light of this disclosure, a lamp 100 configured as variously described herein may be compatible with power sockets/enclosures typically used in existing luminaire structures, such as, for example: MR16 or other multi-faceted reflector (MR) configuration; PAR16, PAR20, PAR30, PAR38, or other parabolic aluminized reflector (PAR) configuration; BR30, BR40, or other bulged reflector (BR) configuration; and 4″-6″ recessed kits, to name a few examples. In some cases, a lamp 100 configured as variously described herein may be considered, in a general sense, a retrofit or other drop-in replacement lighting component, in accordance with some embodiments. As will be appreciated in light of this disclosure, the particular configuration of a lamp 100 may be customized, for instance, to provide a given amount of luminous flux desired for a given target application or end-use.

As can be seen, lamp 100 may include a body portion 102, the material, geometry, and dimensions of which may be customized, as desired for a given target application or end-use. Lamp 100 also may include a base portion 104 configured to be coupled with a given power socket so that power may be delivered to lamp 100 for operation thereof. To that end, base portion 104 may be of any standard, custom, or proprietary contact type and fitting size, as desired for a given target application or end-use. In some cases, base portion 104 may be configured as a threaded lamp base including an electrical foot contact (e.g., such as in FIGS. 1A-1B). In some other cases, base portion 104 may be configured as a bi-pin, tri-pin, or other multi-pin lamp base (e.g., such as in FIG. 2). In some other cases, base portion 104 may be configured as a twist-lock mount lamp base. In some other cases, base portion 104 may be configured as a bayonet connector lamp base. Other suitable configurations for body portion 102 and base portion 104 will depend on a given application and will be apparent in light of this disclosure.

In some embodiments, lamp 100 optionally may include a heatsink portion 106 configured to facilitate heat dissipation for lamp 100. To that end, optional heatsink portion 106 may be formed, in part or in whole, from any suitable thermally conductive material. For instance, optional heatsink portion 106 may be formed from any one, or combination, of aluminum (Al), copper (Cu), gold (Au), brass, steel, or a composite or polymer (e.g., ceramics, plastics, etc.) doped with thermally conductive material(s). The particular configuration, as well as geometry and dimensions, of optional heatsink potion 106 may be customized, as desired for a given target application or end-use. In some embodiments, optional heatsink portion 106 may include a plurality of fins, foils, or other features typically utilized in heat management for electronic components. In some cases, optional heatsink portion 106 may be formed as a single unitary (e.g., monolithic) component, whereas in other cases, it may be formed as an assembly of separate components. Other suitable configurations for optional heatsink portion 106 will depend on a given application and will be apparent in light of this disclosure.

In accordance with some embodiments, lamp 100 may include one or more light source modules 110. FIG. 3A is a cross-sectional side view of a light source module 110 configured in accordance with an embodiment of the present disclosure. FIG. 3B is a cross-sectional side view of a light source module 110 configured in accordance with another embodiment of the present disclosure. A given light source module 110 provided as described herein may be disposed in any desired orientation with respect to host lamp 100. In some cases, lamp 100 may include multiple light source modules 110, at least one of which may be disposed in a first orientation and at least one of which may be disposed in a second, different orientation. In some instances, lamp 100 may include one or more light source modules 110 oriented to provide adjustable direct and/or indirect lighting from a host luminaire, such as a luminaire 300 (discussed below). In some embodiments, lamp 100 may be configured to be operatively coupled with a luminaire to provide either or both upward and downward lighting (e.g., either or both direct and indirect lighting).

A given light source module 110 may include one or more solid state light source emitters 112 configured to emit electromagnetic radiation (e.g., light) from any one, or combination, of spectral bands, such as, for example, the visible spectral band, the infrared (IR) spectral band, and the ultraviolet (UV) spectral band, among others. A given emitter 112 may have any of a wide range of configurations. For instance, in accordance with some embodiments, a given emitter 112 may be a light-emitting diode (LED), an organic light-emitting diode (OLED), a polymer light-emitting diode (PLED), or other semiconductor light source. In some cases, a given emitter 112 may be configured for emissions of a single correlated color temperature (CCT). For instance, a given emitter 112 may be a white light-emitting semiconductor light source device. In some cases, a given emitter 112 may be configured for color-tunable emissions. For instance, a given emitter 112 may be configured for a bi-color, tri-color, or other multi-color combination of emissions, such as red-green-blue (RGB), red-green-blue-yellow (RGBY), red-green-blue-white (RGBW), or dual-white (warm white and cool white), to name a few. In some cases, a given emitter 112 may be configured as a high-brightness semiconductor light source. In an example case, a given emitter 112 may be a high-power semiconductor light source (e.g., about 350 mA or greater, about 1 W or greater). In some instances, a given emitter 112 may include a capacitor, for example, configured to extend the duration that it is illuminated in a multiplexed configuration (described below).

Furthermore, the dimensions and geometry of a given emitter 112 may be customized, as desired for a given target application or end-use. For instance, in some cases, a given emitter 112 may be of generally triangular, quadrilateral, pentagonal, hexagonal, or other polygonal footprint (e.g., as viewed from a top-down vantage). In some other cases, a given emitter 112 may be of generally circular, elliptical, oval, or other curved footprint (e.g., as viewed from a top-down vantage). Other suitable configurations for emitter(s) 112 will depend on a given application and will be apparent in light of this disclosure.

Emitter(s) 112 of a given light source module 110 may be populated over a printed circuit board (PCB) 114 or other suitable intermediate or substrate. A given emitter 112 may be electrically coupled with PCB 114 via any suitable standard, custom, or proprietary electrical coupling means, such as, for example, a wire bond 116, which may be formed as typically done via any suitable electrically conductive material(s) and any suitable technique(s), as will be apparent in light of this disclosure. In some embodiments, emitters 112 of a given light source module 110 may be wired or otherwise communicatively coupled with one another for multiplexing. To that end, in some cases, a given light source module 110 may include one or more planar interconnects between emitters 112. In some cases, PCB 114 further may include other componentry populated there over, such as, for example, resistors, transistors, capacitors, integrated circuits, and power and control connections for a given emitter 112, to name a few examples.

In some embodiments, an optional thermally conductive substrate may be physically coupled, thermally coupled, or both, with PCB 114 of a given light source module 110 and configured to facilitate heat dissipation therefor. To that end, the optional thermally conductive substrate may be formed with any of the example materials discussed above, for instance, with respect to optional heat sink portion 106, in accordance with some embodiments. Other suitable configurations for an optional thermally conductive substrate will depend on a given application and will be apparent in light of this disclosure.

For a given light source module 110, the particular arrangement of emitter(s) 112 over PCB 114 may be customized, as desired for a given target application or end-use. For instance, in some embodiments, emitter(s) 112 may be distributed, in part or in whole, as a regular array in which all (or some sub-set) of emitter(s) 112 are arranged in a systematic manner in relation to one another over PCB 114. In some embodiments, emitter(s) 112 may be distributed, in part or in whole, as a semi-regular array in which a sub-set of emitter(s) 112 are arranged in a systematic manner in relation to one another over PCB 114, but at least one other emitter 112 is not so arranged. In some embodiments, emitter(s) 112 may be distributed, in part or in whole, as an irregular array in which all (or some sub-set) of emitter(s) 112 are not arranged in a systematic manner in relation to one another over PCB 114. The quantity, density, and spacing between neighboring emitters 112 may be customized, as desired for a given target application or end-use. As will be appreciated in light of this disclosure, a greater quantity of emitters 112 may provide for finer control over any one, or combination, of output characteristics (e.g., beam shape, direction, and so forth), for example, whereas a lesser quantity may provide for coarser control over such output characteristics while also simplifying driver and other electronics. Numerous configurations and variations will be apparent in light of this disclosure.

In accordance with some embodiments, a given light source module 110 may include one or more optical elements optically coupled with its emitter(s) 112. For instance, in some embodiments, a given light source module 110 may include an optical layer 118 configured to facilitate focusing of the output of emitter(s) 112. To that end, optical layer 118 may be formed, for example, from a material of high refractive index, such as silicone. As can be seen in FIGS. 3A-3B, such optical layer 118 may be disposed over all (or some sub-set) of the constituent emitter(s) 112 of a given light source module 110, in accordance with some embodiments. The thickness (e.g., y-thickness in the y-direction) of optical layer 118 may be customized, as desired for a given target application or end-use.

In some embodiments, a given light source module 110 optionally may include an optical layer 120 configured to provide for conversion of the output of emitter(s) 112. To that end, optional optical layer 120 may be formed from or otherwise include one or more phosphor materials that convert emissions received thereby to emissions of different wavelength(s). As can be seen in FIG. 3A, in some cases, optional optical layer 120 may be disposed, in part or in whole, over optical layer 118. In such cases, optional optical layer 120 may be shared by all (or some sub-set) of emitter(s) 112 of a light source module 110. As can be seen in FIG. 3B, in some cases, optional optical layer 120 may be disposed over each (or some sub-set) of individual emitter(s) 112 of a light source module 110. In such cases, a given individual emitter 112 may have its own optional optical layer 120, providing for output conversion at the chip level (e.g., at a given individual emitter 112). The thickness (e.g., y-thickness in the y-direction) of optional optical layer 120 may be customized, as desired for a given target application or end-use.

In some embodiments, a given light source module 110 optionally may include an optical layer 122 configured to provide for mixing of the output of emitter(s) 112. To that end, optional optical layer 122 may be formed from or otherwise include a diffuser material. As can be seen in FIG. 3B, in some cases, optional optical layer 122 may be disposed, in part or in whole, over optical layer 118 (and, in some instances, optical layer 120). Other suitable materials and configurations for optical layers 118, 120, and 122 will depend on a given application and will be apparent in light of this disclosure.

It should be noted, however, that the present disclosure is not intended to be limited only to the example optical layers 118, 120, and 122 discussed above, as a given light source module 110 may include one or more additional and/or different optical components, in accordance with some embodiments. For instance, in some cases, a reflective material, such as aluminum oxide (Al₂O₃), may be disposed between individual optional optical layer 120 portions of neighboring emitters 112 in order to prevent or otherwise reduce optical leakage there between. In some cases, a given light source module 110 may include optical features, such as, for example, an anti-reflective (AR) coating, a reflector, a polarizer, or a brightness enhancer, to name a few. Numerous configurations and variations will be apparent in light of this disclosure.

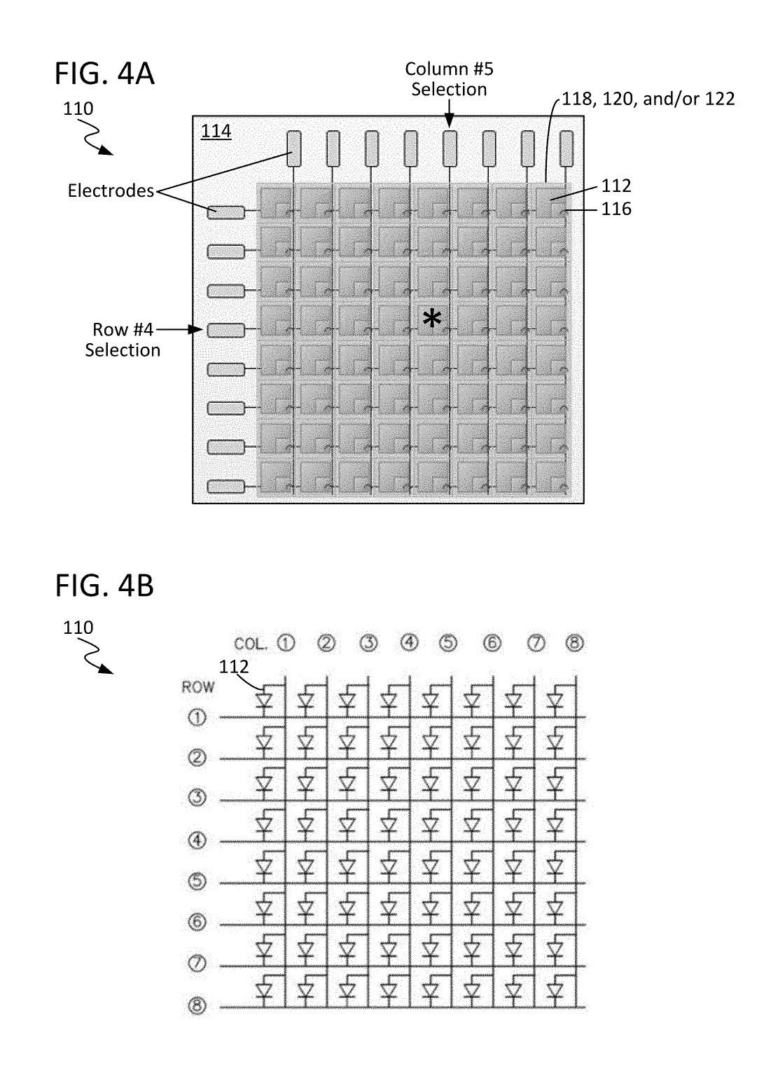

A given light source module 110 provided as described herein may have any of a wide range of configurations. For instance, consider FIGS. 4A-4B, which illustrate a plan view and an electrical schematic, respectively, of a light source module 110 configured in accordance with an embodiment of the present disclosure. As can be seen here, in some cases, a light source module 110 may include a matrix (e.g., a grid of one or more rows and one or more columns) of emitters 112 populated over its PCB 114. In such configurations, a given emitter 112 located at the intersection of a given row and column may be controlled individually, in conjunction with one or more other emitters 112, or both. For instance, by selecting row #4 and column #5 of the matrix of emitters 112 shown in FIG. 4A, the example emitter 112 denoted by an asterisk (*) may be controlled (e.g., turned on/off, brightened/dimmed, and so forth) in this manner. Of course, one or more other emitters 112 also may be controlled simultaneously, if desired, in accordance with some embodiments. For instance, in some cases, any quantity of emitters 112 in a given row or column may be addressed simultaneously, and a given illumination pattern may be achieved by scanning the row or column across remaining emitter(s) 112 in the array. Furthermore, although the specific example case of FIGS. 4A-4B shows a light source module 110 including an 8×8 matrix of emitters 112, the present disclosure is not intended to be so limited, as in a more general sense, and in accordance with some embodiments, the particular quantity of rows and columns for a given matrix of emitters 112 of a light source module 110 may be customized, as desired for a given target application or end-use.

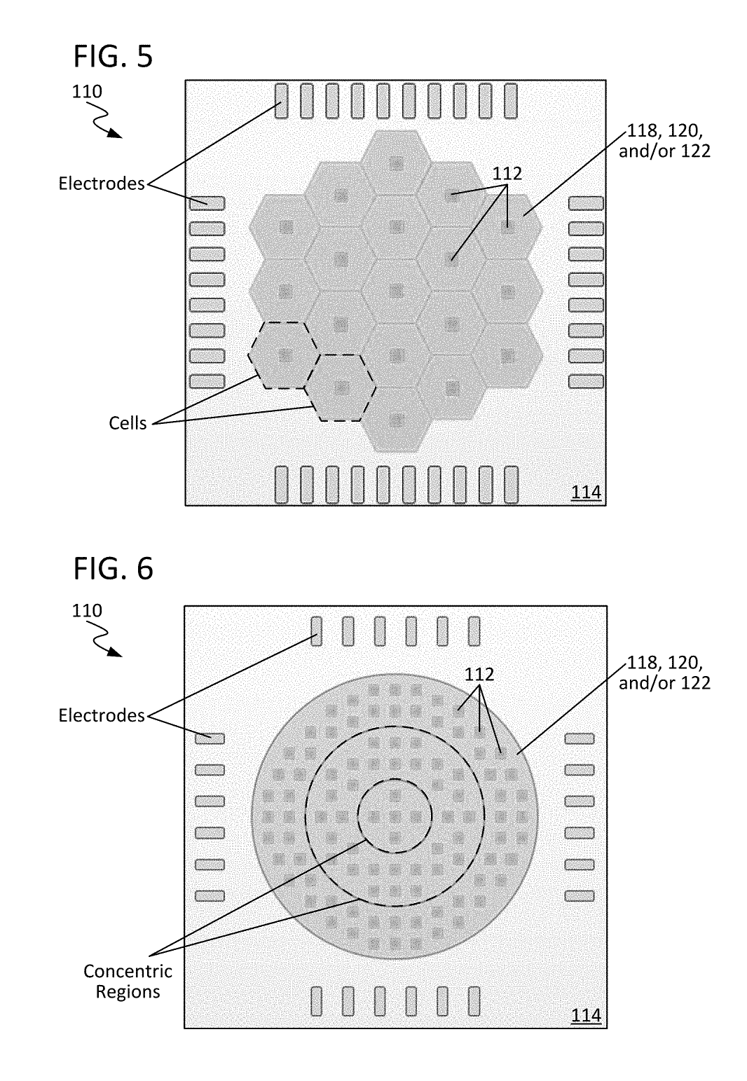

In some embodiments, a light source module 110 may include a polygonal or other line-based arrangement of emitters 112. Some example arrangements include linear, articulated linear, Z-shape, triangular, quadrilateral (e.g., square, rectangular, and so forth), pentagonal, and hexagonal, to name a few. FIG. 5 illustrates a plan view of a light source module 110 including a cellular array of emitters 112 configured in accordance with an embodiment of the present disclosure. As can be seen here, in some cases, emitters 112 may be distributed among one or more neighboring cells. A given cell may include one or a plurality of emitters 112. Neighboring cells may be directly abutting one another (e.g., in contact with one another at one or mode sides or edges) or have one or more intervening elements. Furthermore, a given cell may be of any size and geometry, as desired for a given target application or end-use. Some example cell geometries include triangular, quadrilateral (e.g., square, rectangular, and so forth), pentagonal, and hexagonal, among others. In some cases, a given cell may be of a closed-curve geometry (e.g., circular, elliptical, oval, and so forth). The quantity of cells also may be customized, as desired for a given target application or end-use. Numerous configurations and variations will be apparent in light of this disclosure.

In some embodiments, a light source module 110 may include a closed-curve or other curve-based arrangement of emitters 112. Some example arrangements include arcuate, S-curve, parabolic, circular, elliptical, and oval, to name a few. FIG. 6 illustrates a plan view of a light source module 110 including a concentric array of emitters 112 configured in accordance with an embodiment of the present disclosure. As can be seen here, in some cases, emitters 112 may be distributed among one or more concentrically nested regions or zones. A given region may include one or a plurality of emitters 112. Concentrically nested regions may be directly abutting one another (e.g., in contact with one another at one or more sides or edges) or have one or more intervening elements. Furthermore, a given region may be of any size and geometry, as desired for a given target application or end-use. Some example region geometries include circular, elliptical, oval, and annular, among others. In some cases, a given region may be of a polygonal geometry (e.g., triangular, quadrilateral, pentagonal, hexagonal, and so forth). The quantity of concentric regions or zones also may be customized, as desired for a given target application or end-use. Numerous configurations and variations will be apparent in light of this disclosure.

In each of the aforementioned and other example arrangements of emitters 112 for a given light source module 110, a given individual emitter 112 may be individually controlled by providing power and control signal(s) via electrodes (anode and cathode) corresponding therewith. Also, as previously noted, in some embodiments, emitters 112 of a given light source module 110 may be wired or otherwise communicatively coupled for optional multiplexing, for instance, via one or more interconnects (e.g., planar interconnects or otherwise). Electrical coupling may be provided in series, in parallel, or both, as desired for a given target application or end-use. For any of the example arrangements of FIGS. 4A-4B, 5, and 6, as well as other possible arrangements of emitters 112 of a given light source module 110, all (or some sub-set) of the anodes of a given row, column, cell, region, or other distribution may be electrically connected together, and all (or some sub-set) of the respective cathodes may be electrically connected together, thereby providing a given degree of optional multiplexing, in accordance with some embodiments. In some cases, all of the individual emitters 112 of a given row, column, cell, region, or other geometric sub-structure or zone of a given light source module 110 may be electrically connected in series or parallel (or both), optionally with multiplexing. In some other cases, all of the individual emitters 112 of a given row, column, cell, region, or other geometric sub-structure or zone of a given light source module 110 may not be multiplexed. In some cases, and in accordance with some embodiments, this may facilitate individual control of multiple emitters 112 on a per-zone basis.

As will be further appreciated in light of this disclosure, the size and geometry of a given light source module 110 may be customized, as desired for a given target application or end-use. In some instances, a given light source module 110 may have an area of about 1 in² or less, whereas in other instances, a given light source module 110 may have an area of about 1 in² or greater. In some cases, a given light source module 110 may be of generally triangular, quadrilateral, pentagonal, hexagonal, or other polygonal footprint (e.g., as viewed from a top-down vantage). In some other cases, a given light source module 110 may be of generally circular, elliptical, oval, parabolic, or other curved footprint (e.g., as viewed from a top-down vantage).

As can be seen from FIGS. 1A-1B and 2, for example, lamp 100 also may include one or more optics 108, which may have any of a wide range of configurations. A given optic 108 may be configured to transmit, in part or in whole, emissions received from a given light source module 110 optically coupled therewith, in accordance with some embodiments. A given optic 108 may be configured, in accordance with some embodiments, for focusing or collimating emissions (or both). A given optic 108 may be formed from any one, or combination, of suitable optical materials. For instance, in some embodiments, a given optic 108 may be formed from a polymer, such as poly(methyl methacrylate) (PMMA) or polycarbonate, among others. In some embodiments, a given optic 108 may be formed from a ceramic, such as sapphire (Al₂O₃) or or yttrium aluminum garnet (YAG), among others. In some embodiments, a given optic 108 may be formed from a glass. In some embodiments, a given optic 108 may be formed from a combination of any of the aforementioned materials. Furthermore, the dimensions and geometry of a given optic 108 may be customized, as desired for a given target application or end-use.

In some embodiments, a given optic 108 may be or otherwise include a lens, such as a Fresnel lens, a converging lens, a compound lens, or a micro-lens array, to name a few. In some embodiments, a given optic 108 may be or otherwise include an optical dome or optical window. In some cases, a given optic 108 may be formed as a singular piece of optical material, providing a monolithic optical structure. In some other cases, a given optic 108 may be formed from multiple pieces of optical material, providing a multi-piece optical structure. In some cases, a given optic 108 may include one or more prismatic structures configured to cause emissions exiting that optic 108 to converge or diverge, as desired. Such prismatic structures may be embedded or surficial (or both) and may be configured to provide for a minimal, maximal, or other given degree of beam spot overlap for light beams produced by lamp 100. In some cases, a given optic 108 may be configured to reduce chromatic aberration at high angles.

In some cases, a given optic 108 may be a fixed optical element. In some other cases, a given optic 108 may be an electro-optic tunable optical element configured to be electronically adjusted, thereby providing for electronic adjustment of any one, or combination, of beam direction, beam angle, beam size, beam distribution, intensity, and color, among other emissions characteristics. Other suitable configurations for optic(s) 108 will depend on a given application and will be apparent in light of this disclosure.

In some embodiments, lamp 100 optionally may include a reflector portion 124, such as can be seen, for example, in FIG. 2. Optional reflector portion 124 may be an axial reflector, a side reflector, or other reflector configured as typically done. Optional reflector portion 124 may be formed, in part or in whole, from any one, or combination, of reflective materials, such as silver (Ag), gold (Au), or aluminum (Al), among others. Other suitable configurations for optional reflector portion 124 will depend on a given application and will be apparent in light of this disclosure.

As will be appreciated in light of this disclosure, lamp 100 further may include or otherwise have access to any of a wide range of other electronic components employable with solid state light source-based lighting devices, such as but not limited to lamps and luminaires. For instance, in some embodiments, lamp 100 may include or otherwise have access to power conversion componentry, such as electrical ballast circuitry, configured to convert an AC signal into a DC signal at a desired current/voltage to power a given light source module 110. In some embodiments, lamp 100 may include or otherwise have access to constant current/voltage driver componentry. In some embodiments, lamp 100 may include or otherwise have access to communication componentry (e.g., such as a transmitter, a receiver, or a transceiver) configured for wired or wireless communication (or both) utilizing any suitable means, such as Universal Serial Bus (USB), Ethernet, FireWire, Wi-Fi, Bluetooth, or a combination thereof, among others. In some embodiments, lamp 100 may include or otherwise have access to processing componentry, such as a central processing unit (CPU).

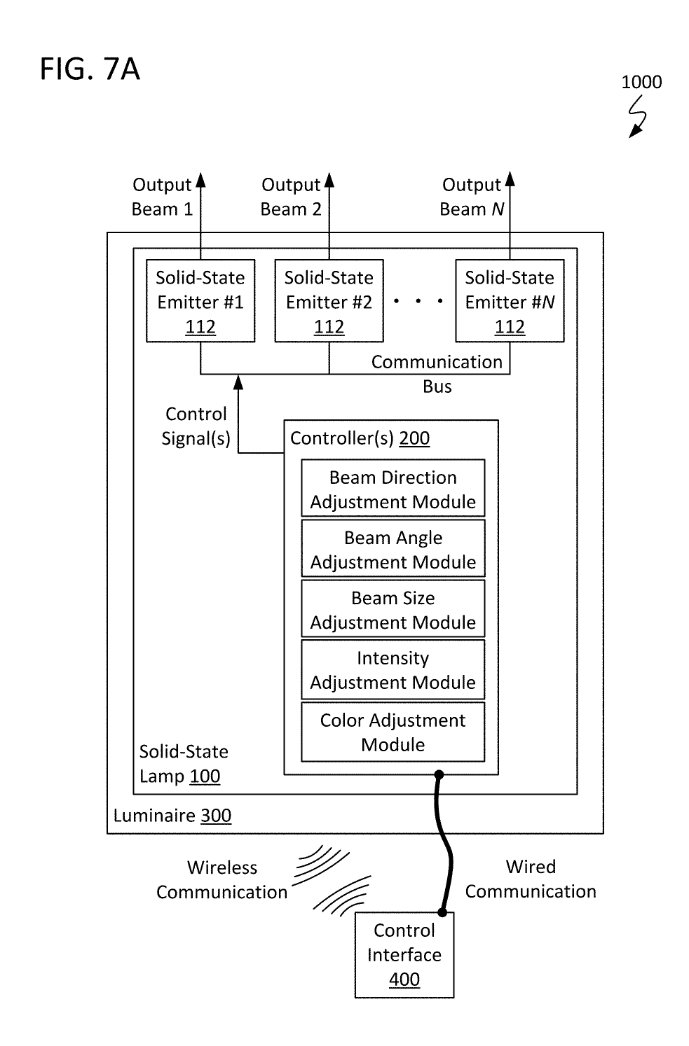

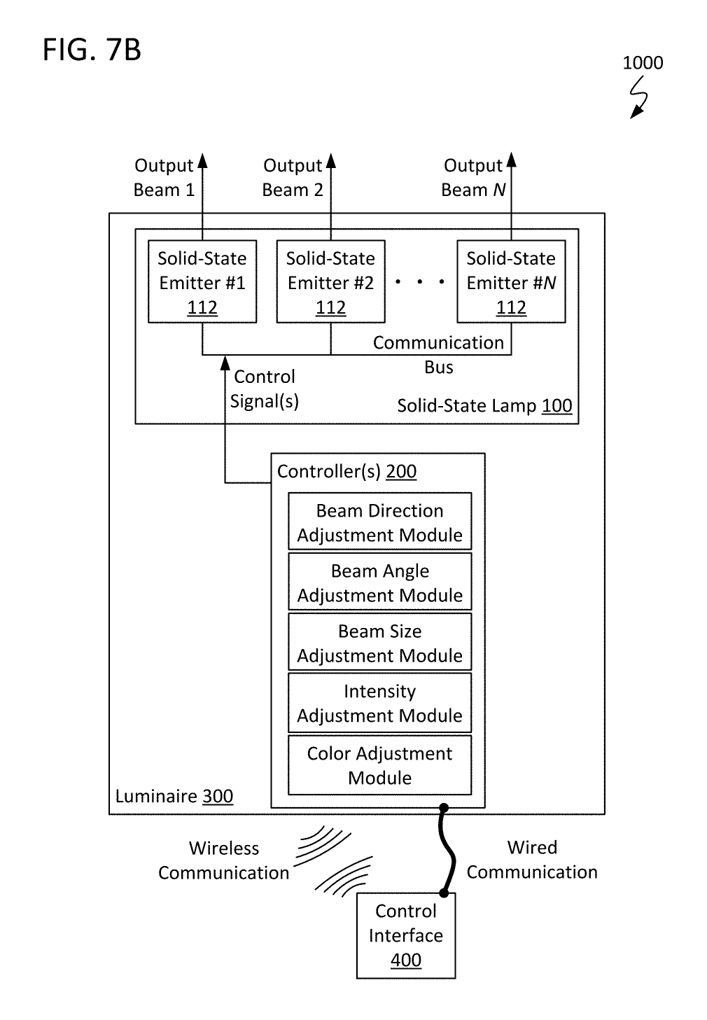

In accordance with some embodiments, lamp 100 may include or otherwise have access to one or more drivers configured to be operatively coupled with emitter(s) 112 of a given module 110. In some cases, a given driver may be native to lamp 100 (e.g., disposed within body portion 102 or other portion of lamp 100) or native to a given emitter 112, whereas in some other cases, a given driver may be native to a luminaire configured to be operatively coupled with lamp 100 (e.g., such as luminaire 300, discussed below with reference to FIGS. 7A-7B). A given driver may be a single-channel or multi-channel electronic driver, and in some cases may be a high-current driver. In accordance with some embodiments, a given driver may be configured to drive a given emitter 112 (or grouping of emitters 112) utilizing any suitable standard, custom, or proprietary driving techniques. In some embodiments, a given driver may be configured to provide dimming of a given emitter 112 (or grouping of emitters 112). To that end, a given driver may employ any one, or combination, of pulse-width modulation (PWM) dimming, current dimming, triode for alternating current (TRIAC) dimming, constant current reduction (CCR) dimming, pulse-frequency modulation (PFM) dimming, pulse-code modulation (PCM) dimming, and line voltage (mains) dimming (e.g., a dimmer is connected before the input of the driver to adjust AC voltage to the driver), among others. In some cases, lamp 100 may include or otherwise have access to a driver configured to provide for electronic adjustment, for example, of the brightness of light, color of light, or both, thereby allowing for dimming, color mixing, color tuning, or a combination of any one or more thereof, as desired for a given target application or end-use. Other suitable driver configurations will depend on a given application and will be apparent in light of this disclosure.

As will be appreciated in light of this disclosure, lamp 100 is not intended to be limited to any particular form factor, as variously shown and described with respect to the figures. Numerous other configurations and variations will be apparent in light of this disclosure. For instance, in some cases, lamp 100 may be configured as a ring-lit solid-state lamp with one or more translucent or transparent annular (or otherwise ring-like) optical portions disposed about body portion 102, in part or in whole, through which emissions of a given light source module 110 may pass. In some cases, lamp 100 may be configured as a tubular solid-state lamp having a generally cylindrical or prismatic shape (optionally with an annular optical portion, previously described) and configured to emit from at least one of its ends. In a more general sense, the particular form factor of a lamp 100 provided as described herein may be customized, as desired for a given target application or end-use, in accordance with some embodiments.

In accordance with some embodiments, a lamp 100 provided as variously described herein may be configured to be operatively coupled with any of a wide range of luminaires 300 (FIGS. 7A-7B). For instance, in some cases, lamp 100 may be compatible with a luminaire 300 configured as a recessed light, a pendant light, a sconce, or the like, which may be mounted on or suspended from, for example, a ceiling, wall, floor, step, or other suitable surface, as will be apparent in light of this disclosure. In some cases, lamp 100 may be compatible with a luminaire 300 configured as a free-standing lighting device, such as a desk lamp or torchière lamp. In some embodiments, lamp 100 may be compatible with a luminaire 300 configured to be mounted, for example, on a drop ceiling tile (e.g., 1 ft.×1 ft., 2 ft.×2 ft., 2 ft.×4 ft., 4 ft.×4 ft., or larger) for installation in a drop ceiling grid. In some embodiments, lamp 100 may be compatible with a luminaire 300 configured, for instance, to substitute for a drop ceiling tile in a drop ceiling grid. In some embodiments, lamp 100 may be compatible with a luminaire 300 configured to be embedded, in part or in whole, into a given mounting surface (e.g., plastered into a ceiling, wall, or other structure). Numerous suitable configurations will be apparent in light of this disclosure.

Output Control

As noted above, a given emitter 112 may be addressable individually, in one or more groupings, or a combination thereof. As such, the emitter(s) 112 of a given light source module 110 may be electronically controlled so as to provide lamp 100 with an electronically adjustable light beam distribution capable of highly adjustable light emissions, in accordance with some embodiments. To such ends, lamp 100 may include or otherwise be configured for communicative coupling with one or more controllers 200, in accordance with some embodiments. In some cases, a given controller 200 may be native to lamp 100. For instance, consider FIG. 7A, which is a block diagram of a lighting system 1000 including a lamp 100 hosting a controller 200, in accordance with an embodiment of the present disclosure. In some cases, all (or some sub-set) of emitters 112 of a given light source module 110 may include its own controller 200. Thus, each such controller 200 may be considered, in a sense, a mini-controller, providing an overall distributed controller 200. In some other cases, a given controller 200 may not be native to lamp 100. For instance, consider FIG. 7B, which is a block diagram of a lighting system 1000 including a lamp 100 and a controller 200 therefor, in accordance with another embodiment of the present disclosure.

A given controller 200 may host one or more lighting control modules and may be programmed or otherwise configured to output one or more control signals that may be utilized in controlling the operation of a given emitter 112 of a given light source module 110, in accordance with some embodiments. For instance, in some embodiments, a given controller 200 may include a beam direction adjustment module and may be configured to output control signal(s) to control the beam direction of the light beam emitted by a given emitter 112 of a light source module 110. In some embodiments, a given controller 200 may include a beam angle adjustment module and may be configured to output control signal(s) to control the beam angle of the light beam emitted by a given emitter 112 of a light source module 110. In some embodiments, a given controller 200 may include a beam size adjustment module and may be configured to output control signal(s) to control the beam size (e.g., diameter or other width) of the light beam emitted by a given emitter 112 of a light source module 110. In some embodiments, a given controller 200 may include an intensity adjustment module and may be configured to output control signal(s) to control the intensity (e.g., brightness or dimness) of the light emitted by a given emitter 112 of a light source module 110. In some embodiments, a given controller 200 may include a color adjustment module and may be configured to output control signal(s) to control the color (e.g., wavelength) of the light emitted by a given emitter 112 of a light source module 110.

In some cases, a given controller 200 may be configured to output control signal(s) for use in controlling whether a given emitter 112 is in an on state or an off state. In some cases, a given controller 200 may be configured to output control signal(s) to mix or otherwise tune the emissions of emitter(s) 112 of a light source module 110. For instance, if a given light source module 110 includes, for example, two or more emitters 112 configured to emit light having different wavelengths, control signal(s) provided by a given controller 200 may be utilized to adjust the relative brightness of the different emitters 112 in order to change the mixed color output of that light source module 110. If a given light source module 110 is configured for multi-colored emissions, emitter(s) 112 thereof may be electronically controlled, for example, so as to adjust the color of light distributed at different angles or directions (or both), in accordance with some embodiments. In some cases, a given controller 200 may be configured to output control signal(s) to control any one, or combination, of color saturation and correlated color temperature (CCT). In some cases, a given controller 200 may be configured to output control signal(s) to control the pattern or shape of the emissions of emitter(s) 112 of a light source module 110. For instance, control signal(s) provided by a given controller 200 may be utilized in adjusting the output of emitter(s) 112 to produce, for example, a batwing or a flood distribution, or a pattern such as an arrow or a star, to name a few examples.

It should be noted, however, that the present disclosure is not intended to be limited only to these example lighting control modules and output signals. Additional and/or different lighting control modules and output signals may be provisioned, as desired for a given target application or end-use. Numerous variations and configurations will be apparent in light of this disclosure.

In accordance with some embodiments, the module(s) of a given controller 200 can be implemented in any suitable standard, custom, or proprietary programming language, such as, for example, C, C++, objective C, JavaScript, or any other suitable instruction set, as will be apparent in light of this disclosure. The module(s) of a given controller 200 can be encoded, for example, on a machine-readable medium that, when executed by a processor, carries out the functionality of lamp 100, in part or in whole. The computer-readable medium may be, for example, a hard drive, a compact disk, a memory stick, a server, or any suitable non-transitory computer or computing device memory that includes executable instructions, or a plurality or combination of such memories. Some embodiments can be implemented, for instance, with gate-level logic, an application-specific integrated circuit (ASIC) or chip set, or other such purpose-built logic. Some embodiments can be implemented with a microcontroller having input/output capability (e.g., inputs for receiving user inputs; outputs for directing other components) and a number of embedded routines for carrying out device functionality. In a more general sense, the functional modules of a given controller 200 can be implemented in any one, or combination, of hardware, software, and firmware, as desired for a given target application or end-use.

In accordance with some embodiments, lamp 100 may be electronically controlled in a manner so as to output any number of output beams (1-N), which may be varied in any one, or combination, of beam direction, beam angle, beam size, beam distribution, intensity, and color, as desired for a given target application or end-use. To such ends, a given controller 200 may be operatively coupled with a given emitter 112 of a light source module 110, for instance, by a communication bus or other suitable interconnect, as will be apparent in light of this disclosure. A given controller 200 may be configured to communicate via any, or combination, of suitable standard, custom, or proprietary wired or wireless digital communications protocols. Some examples include a digital multiplexer (DMX) interface protocol, a Wi-Fi protocol, Bluetooth protocol, a digital addressable lighting interface (DALI) protocol, a ZigBee protocol, a KNX protocol, an EnOcean protocol, a TransferJet protocol, an ultra-wideband (UWB) protocol, a WiMAX protocol, a high performance radio metropolitan area network (HiperMAN) protocol, an infrared data association (IrDA) protocol, a Li-Fi protocol, an IPv6 over low power wireless personal area network (6LoWPAN) protocol, a MyriaNed protocol, a WirelessHART protocol, a DASH7 protocol, a near field communication (NFC) protocol, a Wavenis protocol, a RuBee protocol, a Z-Wave protocol, an Insteon protocol, a ONE-NET protocol, and an X10 protocol, among others.

In some cases, a given controller 200 may be configured as a terminal block or other pass-through such that a given control interface 400 (discussed below) is effectively coupled directly with the individual emitter(s) 112 of a given light source module 110 of a lamp 100. In some other embodiments, a transistor or driver may be integrated into a given emitter 112, and a controller 200 (e.g., a control wire) may be used to control the on/off state or other attribute of such emitter 112. Numerous suitable configurations and variations will be apparent in light of this disclosure.

In accordance with some embodiments, a given controller 200 may be configured to output control signal(s) to emitter(s) 112 based, at least in part, on input received from one or more control interfaces 400, which may be physical, virtual, or a combination thereof. To that end, a given control interface 400 may be configured to communicate via any one, or combination, of suitable wired or wireless digital communications protocols, such as any of the example protocols discussed above, for instance, with respect to controller(s) 200. In some cases, a given control interface 400 may be configured as a user interface that facilitates manipulation of the light output of a given light source module 110 of a lamp 100.

In some embodiments, a given control interface 400 may include a physical control layer configured for use in controlling emitter(s) 112 of a light source module 110. The physical control layer may be or otherwise include any one, or combination, of physical switches, such as a sliding switch, a rotary switch, a toggle switch, or a push-button switch, to name a few. In some cases, a given switch may be operatively coupled with a given controller 200, which in turn interprets switch input and distributes desired control signal(s) to emitter(s) 112. In some cases, a given switch may be operatively coupled directly with emitter(s) 112 to control them directly.

In some embodiments, a given control interface 400 may include a software control layer configured for use in controlling emitter(s) 112 of a light source module 110. The software control layer may be configured to customize the lighting distribution in a given space, for example, by intelligently controlling emitter(s) 112. For instance, the software control layer may be configured, in some embodiments, to intelligently determine how to adjust (e.g., turn on/off, dim/brighten, and so forth) the output level of one or more individual emitters 112 to achieve a given output brightness level or color (or both).

In some cases, a given control interface 400 may be a graphical user interface (GUI) provided by a computing device, mobile or otherwise. In accordance with some embodiments, a control interface 400 may be configured as described in U.S. patent application Ser. No. 14/221,589, filed Mar. 21, 2014, titled “Techniques and Graphical User Interface for Controlling Solid-State Luminaire with Electronically Adjustable Light Beam Distribution,” which is incorporated by reference herein in its entirety. In accordance with some embodiments, a control interface 400 may be configured as described, for instance, in U.S. patent application Ser. No. 14/221,638, filed Mar. 21, 2014, titled “Techniques and Photographical User Interface for Controlling Solid-State Luminaire with Electronically Adjustable Light Beam Distribution,” which is incorporated by reference herein in its entirety.

In some embodiments, a touch-sensitive display or surface, such as a touchpad or other device with a touch-based user interface (UI), may be utilized in controlling the emitter(s) 112 of a given light source module 110 of lamp 100 individually, in conjunction with one another (e.g., as one or more groupings of emitters 112), or both. In some instances, the touch-sensitive UI may be operatively coupled with one or more controllers 200, which in turn interpret the input from the control interface 400 and provide the desired control signal(s) to one or more emitters 112 of a lamp 100. In some other instances, the touch-sensitive UI may be operatively coupled directly with one or more emitters 112 to control them directly. In some cases, touch-based input may be utilized to manipulate beam distribution, in any one, or combination, of beam direction, beam angle, beam size, beam distribution, intensity, and color, to adjust lighting in a given target space.

In some embodiments, a computer vision system that is, for example, gesture-sensitive, activity-sensitive, motion-sensitive, or a combination of any one or more thereof, may be utilized to control emitter(s) 112 of a given light source module 110 of a lamp 100 individually, in conjunction with one another (e.g., as one or more groupings of emitters 112), or both. In some such cases, this may provide for a lamp 100 which can automatically adapt its light emissions based on a particular gesture-based command, sensed activity, or other stimulus. In some instances, the computer vision system may be operatively coupled with one or more controllers 200, which in turn interpret the input from the control interface 400 and provide the desired control signal(s) to one or more of the emitters 112 of a lamp 100. In some other instances, the computer vision system may be operatively coupled directly with one or more emitters 112 to control them directly. In accordance with some embodiments, the output of emitter(s) 112 of a light source module 110 may be controlled, in part or in whole, based on hand gestures or other movements detected, for example, by a camera or other image capture device communicatively coupled with lamp 100 (and/or a luminaire 300 hosting that lamp 100). In some cases, detected motion may be utilized to manipulate beam distribution, in any one, or combination, of beam direction, beam angle, beam size, beam distribution, intensity, and color, to adjust lighting in a given target space. Other suitable configurations and capabilities for a given controller 200 and a given control interface 400 will depend on a given application and will be apparent in light of this disclosure.

In some embodiments, lamp 100 may be configured, for example, such that no two of its emitters 112 are pointed at the same spot on a given surface of incidence. Thus, there may be a one-to-one mapping of the emitters 112 of lamp 100 to the light beam spots which it may produce on a given surface of incidence. This one-to-one mapping may provide for pixelated control over the light distribution of lamp 100, in accordance with some embodiments. That is, lamp 100 may be capable of outputting a polar, grid-like pattern of light beam spots which can be manipulated (e.g., in intensity, size, and so forth), for instance, like the regular, rectangular grid of pixels of a display. Like the pixels of a display, the beam spots produced by lamp 100 can have minimal, maximal, or other targeted amount of overlap, as desired, in accordance with some embodiments. This may allow for the light distribution of lamp 100 to be manipulated in a manner similar to the way that the pixels of a display can be manipulated to create different patterns, spot shapes, and distributions of light, in accordance with some embodiments. Furthermore, lamp 100 may exhibit minimal or otherwise negligible overlap of the angular distributions of light of its emitters 112, and thus the light distribution can be adjusted (e.g., in intensity, size, and so forth) as desired for a given target application or end-use. As will be appreciated in light of this disclosure, however, lamp 100 also may be configured to provide for pointing two or more emitters 112 at the same spot (e.g., such as when color mixing using multiple color emitters 112 is desired), in accordance with some embodiments.

Example Output Distributions

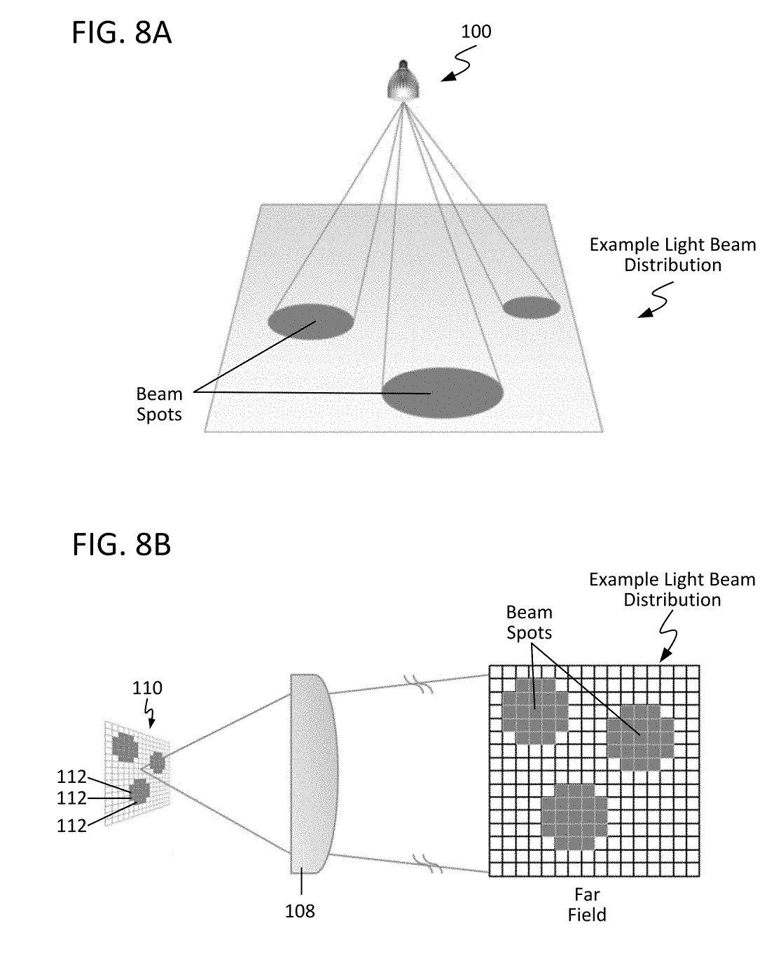

As described herein, a given emitter 112 may be controlled individually, as part of one or more groupings, or both, providing a host lamp 100 with a highly customizable light beam distribution. FIGS. 8A-8B illustrate an example light beam distribution produced via a lamp 100 including a light source module 110 configured as in FIGS. 4A-4B, in accordance with an embodiment of the present disclosure. As generally shown here, the emissions of emitter(s) 112 of a light source module 110 pass through one or more optics 108, imaging into the far field, for instance, as one or more adjustable off-axis beam spots (though they need not be off-axis). By controlling the output of a given contributing emitter 112, lamp 100 is provided, in a general sense, with pixelated illumination control, in accordance with some embodiments.

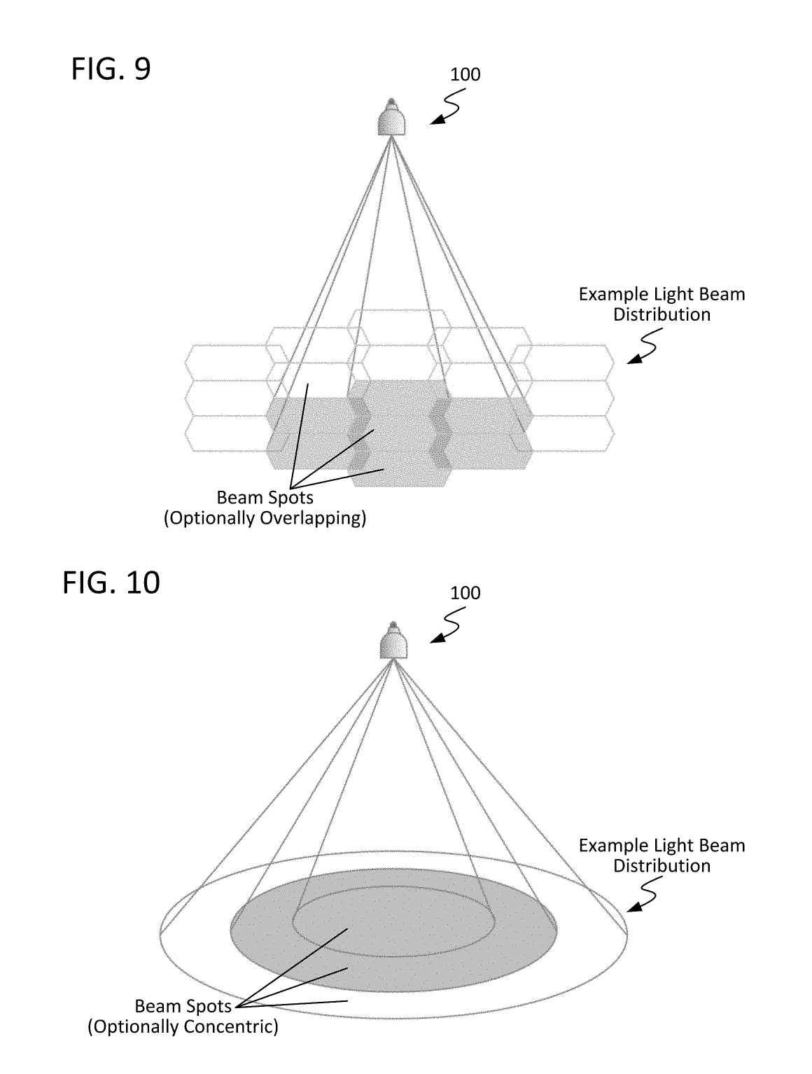

FIG. 9 illustrates an example light beam distribution produced via a lamp 100 including a light source module 110 configured as in FIG. 5, in accordance with an embodiment of the present disclosure. As can be seen, given that the light source module 110 of FIG. 5 includes an array of cells of hexagonal geometry, the light beam spots of the example distribution here in FIG. 9 are correspondingly generally hexagonal in geometry. However, the present disclosure is not intended to be so limited, as other cell geometries (e.g., rectangular, circular, and so forth) may produce other corresponding light beam spot geometries, in accordance with other embodiments. Moreover, the particular geometry of a given cell does not necessarily dictate the particular geometry of a light beam spot produced by the emitter(s) 112 of that cell. For instance, a given cell could be of a first geometry (e.g., hexagonal) and a light beam spot produced could be of a second, different geometry (e.g., elliptical), in accordance with some embodiments. In some cases, such as that generally depicted in FIG. 9, lamp 100 may be configured such that light beam spots produced by its light source module(s) 110 may be controlled so as to provide some degree of intentional beam spot overlapping. The amount of optional overlap between light beam spots may be minimized, maximized, or otherwise customized, as desired for a given target application or end-use.

FIG. 10 illustrates an example light beam distribution produced via a lamp 100 including a light source module 110 configured as in FIG. 6, in accordance with an embodiment of the present disclosure. As can be seen, given that the light source module 110 of FIG. 6 includes an array of concentrically nested, circular regions, the light beam spots of the example distribution here in FIG. 10 are correspondingly concentrically nested and generally circular. However, the present disclosure is not intended to be so limited, as other region geometries (e.g., rectangular, elliptical, and so forth) may produce other corresponding light beam spot geometries, in accordance with other embodiments. Moreover, the particular geometry of a given region does not necessarily dictate the particular geometry of a light beam spot produced by the emitter(s) 112 of that region. For instance, a given region could be of a first geometry (e.g., circular or annular) and a light beam spot produced could be of a second, different geometry (e.g., elliptical or linear), in accordance with some embodiments. In some cases, such as that generally depicted in FIG. 10, lamp 100 may be configured such that light beam spots produced by its light source module(s) 110 may be controlled so as to provide seamless, but not overlapping (or only minimally overlapping), beam spots.

Some embodiments may provide for accent lighting or area lighting of any of a wide variety of distributions (e.g., narrow, wide, asymmetrical, tilted, Gaussian, batwing, or other specifically shaped light beam distribution). By turning on/off, dimming, or otherwise adjusting the output of various combinations of emitters 112 of a light source module 110 of a lamp 100, the light beam output may be adjusted, for instance, to produce uniform illumination on a given surface, to fill a given space with light, or to generate any desired area lighting distributions. In an example case, a batwing beam distribution may be created, for instance, by reducing the intensity of the central emitters 112 of a light source module 110. In another example case, multiple beam spots may be provided to illuminate different regions or objects in a given space. As will be appreciated in light of this disclosure, numerous lighting effects may be generated via a lamp 100 including one or more light source modules 110 configured as variously described herein.

[BEGIN BOILERPLATE INCLUDING BEAUREGARD LANGUAGE—NOTE: remove Beauregard language if the invention does NOT involve software!]The methods and systems described herein are not limited to a particular hardware or software configuration, and may find applicability in many computing or processing environments. The methods and systems may be implemented in hardware or software, or a combination of hardware and software. The methods and systems may be implemented in one or more computer programs, where a computer program may be understood to include one or more processor executable instructions. The computer program(s) may execute on one or more programmable processors, and may be stored on one or more storage medium readable by the processor (including volatile and non-volatile memory and/or storage elements), one or more input devices, and/or one or more output devices. The processor thus may access one or more input devices to obtain input data, and may access one or more output devices to communicate output data. The input and/or output devices may include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processor as provided herein, where such aforementioned examples are not exhaustive, and are for illustration and not limitation.

The computer program(s) may be implemented using one or more high level procedural or object-oriented programming languages to communicate with a computer system; however, the program(s) may be implemented in assembly or machine language, if desired. The language may be compiled or interpreted.

As provided herein, the processor(s) may thus be embedded in one or more devices that may be operated independently or together in a networked environment, where the network may include, for example, a Local Area Network (LAN), wide area network (WAN), and/or may include an intranet and/or the internet and/or another network. The network(s) may be wired or wireless or a combination thereof and may use one or more communications protocols to facilitate communications between the different processors. The processors may be configured for distributed processing and may utilize, in some embodiments, a client-server model as needed. Accordingly, the methods and systems may utilize multiple processors and/or processor devices, and the processor instructions may be divided amongst such single- or multiple-processor/devices.

The device(s) or computer systems that integrate with the processor(s) may include, for example, a personal computer(s), workstation(s) (e.g., Sun, HP), personal digital assistant(s) (PDA(s)), handheld device(s) such as cellular telephone(s) or smart cellphone(s), laptop(s), handheld computer(s), or another device(s) capable of being integrated with a processor(s) that may operate as provided herein. Accordingly, the devices provided herein are not exhaustive and are provided for illustration and not limitation.

References to “a microprocessor” and “a processor”, or “the microprocessor” and “the processor,” may be understood to include one or more microprocessors that may communicate in a stand-alone and/or a distributed environment(s), and may thus be configured to communicate via wired or wireless communications with other processors, where such one or more processor may be configured to operate on one or more processor-controlled devices that may be similar or different devices. Use of such “microprocessor” or “processor” terminology may thus also be understood to include a central processing unit, an arithmetic logic unit, an application-specific integrated circuit (IC), and/or a task engine, with such examples provided for illustration and not limitation.

Furthermore, references to memory, unless otherwise specified, may include one or more processor-readable and accessible memory elements and/or components that may be internal to the processor-controlled device, external to the processor-controlled device, and/or may be accessed via a wired or wireless network using a variety of communications protocols, and unless otherwise specified, may be arranged to include a combination of external and internal memory devices, where such memory may be contiguous and/or partitioned based on the application. Accordingly, references to a database may be understood to include one or more memory associations, where such references may include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, may include one or more intranets and/or the internet. References herein to microprocessor instructions or microprocessor-executable instructions, in accordance with the above, may be understood to include programmable hardware.

Unless otherwise stated, use of the word “substantially” may be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” and/or “an” and/or “the” to modify a noun may be understood to be used for convenience and to include one, or more than one, of the modified noun, unless otherwise specifically stated. The terms “comprising”, “including” and “having” are intended to be inclusive and mean that there may be additional elements other than the listed elements.

Elements, components, modules, and/or parts thereof that are described and/or otherwise portrayed through the figures to communicate with, be associated with, and/or be based on, something else, may be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. Many additional changes in the details, materials, and arrangement of parts, herein described and illustrated, may be made by those skilled in the art.

1. A solid-state lamp comprising:
a light source module comprising:
a printed circuit board (PCB); and
a plurality of solid-state emitters populated over the PCB in a matrix arrangement comprising at least one row and at least one column, wherein at least one solid-state emitter of the plurality is addressable at least one of individually and in one or more groupings to customize its emissions;
one or more optics configured to be optically coupled with the light source module and to transmit output thereof, wherein the one or more optics comprises at least a first optical layer disposed over the at least one solid-state emitter and configured to focus emissions thereof and a second optical layer disposed over the at least one solid-state emitter and configured to convert emissions thereof to emissions of different wavelengths, and wherein the first optical layer is disposed directly on the at least one solid-state emitter, and the second optical layer is disposed directly on the first optical layer; and
a controller configured to be communicatively coupled with the at least one solid-state emitter and to output a control signal to electronically control emissions of the at least one solid-state emitter so as to provide pixelated control over light distribution of the solid-state lamp.

2. The solid-state lamp of claim 1, wherein at least a portion of the plurality of solid-state emitters are multiplexed such that, for a given row or column:
anodes of solid-state emitters of the row or column are connected together; and
cathodes of solid-state emitters of the row or column are connected together.

3. The solid-state lamp of claim 1, wherein the control signal adjusts at least one of beam direction, beam angle, beam size, beam distribution, brightness, and color of emissions of the at least one solid-state emitter.

4. The solid-state lamp of claim 1, wherein the controller is configured to electronically control the plurality of solid-state emitters at least one of independently and in one or more groupings.

5. The solid-state lamp of claim 1 further comprising at least one of:
a driver integrated with the at least one solid-state emitter and configured to adjust emissions thereof via at least one of pulse-width modulation (PWM) dimming, current dimming, triode for alternating current (TRIAC) dimming, constant current reduction (CCR) dimming, pulse-frequency modulation (PFM) dimming, pulse-code modulation (PCM) dimming, and line voltage (mains) dimming; and
a transistor integrated with the at least one solid-state emitter and configured to adjust an on/off state thereof.

6. The solid-state lamp of claim 1, wherein the one or more optics further comprise
a third optical layer disposed over the at least one solid-state emitter and configured to diffuse emissions thereof.

7. (canceled)

8. (canceled)

9. A lighting system comprising:
a solid-state lamp configured as in claim 1; and
at least one of:
a luminaire configured to be operatively coupled with the solid-state lamp; and
a control interface configured to be communicatively coupled with the solid-state lamp and to output a signal that adjusts at least one of beam direction, beam angle, beam diameter, beam distribution, brightness, and color of emissions of the at least one of solid-state emitter.

10. A solid-state lamp comprising:
a light source module comprising:
a printed circuit board (PCB); and
a plurality of solid-state emitters populated over the PCB in a cellular array comprising a plurality of neighboring cells, wherein at least one solid-state emitter of the plurality is addressable at least one of individually and in one or more groupings to customize its emissions;
one or more optics configured to be optically coupled with the light source module and to transmit output thereof, wherein the one or more optics comprises at least a first optical layer disposed over the at least one solid-state emitter and configured to focus emissions thereof and a second optical layer disposed over the at least one solid-state emitter and configured to convert emissions thereof to emissions of different wavelengths, and wherein the first optical layer is disposed directly on the at least one solid-state emitter, and the second optical layer is disposed directly on the first optical layer; and
a controller configured to be communicatively coupled with the at least one solid-state emitter and to output a control signal to electronically control emissions of the at least one solid-state emitter so as to provide pixelated control over light distribution of the solid-state lamp.

11. The solid-state lamp of claim 10, wherein at least a portion of the plurality of solid-state emitters are multiplexed such that, for a given cell:
anodes of solid-state emitters of the cell are connected together; and
cathodes of solid-state emitters of the cell are connected together.

12. The solid-state lamp of claim 10, wherein the control signal adjusts at least one of beam direction, beam angle, beam size, beam distribution, brightness, and color of emissions of the at least one solid-state emitter.

13. The solid-state lamp of claim 10, wherein the controller is configured to electronically control the plurality of solid-state emitters at least one of independently and in one or more groupings.

14. The solid-state lamp of claim 10 further comprising at least one of:
a driver integrated with the at least one solid-state emitter and configured to adjust emissions thereof via at least one of pulse-width modulation (PWM) dimming, current dimming, triode for alternating current (TRIAC) dimming, constant current reduction (CCR) dimming, pulse-frequency modulation (PFM) dimming, pulse-code modulation (PCM) dimming, and line voltage (mains) dimming; and
a transistor integrated with the at least one solid-state emitter and configured to adjust an on/off state thereof.

15. The solid-state lamp of claim 10, wherein the one or more optics further comprise
a third optical layer disposed over the at least one solid-state emitter and configured to diffuse emissions thereof.

16. (canceled)

17. (canceled)

18. A lighting system comprising:
a solid-state lamp configured as in claim 10; and
at least one of:
a luminaire configured to be operatively coupled with the solid-state lamp; and
a control interface configured to be communicatively coupled with the solid-state lamp and to output a signal that adjusts at least one of beam direction, beam angle, beam diameter, beam distribution, brightness, and color of emissions of the at least one of solid-state emitter.

19. A solid-state lamp comprising:
a light source module comprising:
a printed circuit board (PCB); and
a plurality of solid-state emitters populated over the PCB in a concentric array comprising a plurality of concentrically nested regions, wherein at least one solid-state emitter of the plurality is addressable at least one of individually and in one or more groupings to customize its emissions;
one or more optics configured to be optically coupled with the light source module and to transmit output thereof, wherein the one or more optics comprises at least a first optical layer disposed over the at least one solid-state emitter and configured to focus emissions thereof and a second optical layer disposed over the at least one solid-state emitter and configured to convert emissions thereof to emissions of different wavelengths, and wherein the first optical layer is disposed directly on the at least one solid-state emitter, and the second optical layer is disposed directly on the first optical layer; and
a controller configured to be communicatively coupled with the at least one solid-state emitter and to output a control signal to electronically control emissions of the at least one solid-state emitter so as to provide pixelated control over light distribution of the solid-state lamp.

20. The solid-state lamp of claim 19, wherein at least a portion of the plurality of solid-state emitters are multiplexed such that, for a given region:
anodes of solid-state emitters of the region are connected together; and
cathodes of solid-state emitters of the region are connected together.

21. The solid-state lamp of claim 19, wherein the control signal adjusts at least one of beam direction, beam angle, beam size, beam distribution, brightness, and color of emissions of the at least one solid-state emitter.

22. The solid-state lamp of claim 19, wherein the controller is configured to electronically control the plurality of solid-state emitters at least one of independently and in one or more groupings.

23. The solid-state lamp of claim 19 further comprising at least one of:
a driver integrated with the at least one solid-state emitter and configured to adjust emissions thereof via at least one of pulse-width modulation (PWM) dimming, current dimming, triode for alternating current (TRIAC) dimming, constant current reduction (CCR) dimming, pulse-frequency modulation (PFM) dimming, pulse-code modulation (PCM) dimming, and line voltage (mains) dimming; and
a transistor integrated with the at least one solid-state emitter and configured to adjust an on/off state thereof.

24. The solid-state lamp of claim 19, wherein the one or more optics further comprise
a third optical layer disposed over the at least one solid-state emitter and configured to diffuse emissions thereof.

25. (canceled)

26. (canceled)

27. The solid-state lamp of claim 19, wherein at least one of the one or more optics is configured as at least one of a Fresnel lens, a converging lens, a compound lens, a micro-lens array, an electro-optic tunable lens, a dome, and a window, and comprises at least one of poly(methyl methacrylate), polycarbonate, sapphire, yttrium aluminum garnet, and a glass.

28. A lighting system comprising:
a solid-state lamp configured as in claim 19; and
at least one of:
a luminaire configured to be operatively coupled with the solid-state lamp; and
a control interface configured to be communicatively coupled with the solid-state lamp and to output a signal that adjusts at least one of beam direction, beam angle, beam diameter, beam distribution, brightness, and color of emissions of the at least one of solid-state emitter.
